(19) United States
(12) Patent Application Publication
(10) Pub. No.: US 2021/0268734 A1
(43) Pub. Date: Sep. 2, 2021

(54) FLUID MATERIAL DISPENSING APPARATUS

(71) Applicant: SEIKO EPSON CORPORATION, Tokyo (JP)

(72) Inventors: Eiji OKAMOTO, Matsumoto (JP); Masaya ISHIDA, Torrance, CA (US); Akihiko TSUNOYA, Okaya (JP); Takeshi MIYASHITA, Suwa (JP); Naoko SHIMA, Shiojiri (JP)

(21) Appl. No.: 16/336,432

(22) PCT Filed: Sep. 12, 2017
(86) PCT No.: PCT/JP2017/032896

§ 371 Date: Mar. 25, 2019

(30) Foreign Application Priority Data
Sep. 26, 2016 (JP) 2016-187175

(51) Int. Cl. B29C 64/209; B29C 64/393; B33Y 30/00; B33Y 50/02

(52) U.S. Cl. CPC B29C 64/209; B33Y 50/02; B33Y 30/00; B29C 64/393

(57) ABSTRACT

A fluid-material-dispensing-apparatus includes a setting section of a cartridge containing a fluid material, a material chamber to which the fluid material is supplied, a valve seat constituting a part of the material chamber and including a dispensing port, a piston configured to move inside the material chamber in a direction toward or away from the dispensing port, and a drive unit for the piston. The cartridge is detachable, and a plurality of cartridges respectively containing different fluid materials can be employed. At least one of the valve seat and the piston is detachable, and a plurality of detachable members respectively having different structures can be employed. The detachable members each include a structure information provider of a corresponding structure. The fluid-material-dispensing-apparatus includes an information reader that reads information from a material information provider, and the structure information provider.

### BACKGROUND

### Technical Field

The present invention relates to a fluid material dispensing apparatus.

### Related Art

Fluid material dispensing apparatuses, configured to supply a fluid material to a material chamber and drive a piston in the material chamber, to thereby dispense the fluid material through a dispensing port formed in the material chamber, have thus far been known.

For example, International Publication No. 2008/108097 discloses a liquid droplet dispensing apparatus (fluid material dispensing apparatus), configured to supply a liquid to a liquid chamber and drive a piston in the liquid chamber, to thereby dispense the liquid through a dispensing port formed in the liquid chamber.

Recently, users have come to require the fluid material dispensing apparatus to dispense different kinds of fluid materials. For example, when the fluid material dispensing apparatus is utilized to form a 3D object, fluid materials of different properties, as well as fluid materials containing various components of the 3D object, are employed. To properly dispense the fluid material, a driving condition of a piston, the piston to be used (diameter, size, shape, and material), and a material chamber to be employed (shape, aperture area of dispensing port, and material), vary depending on the type of the fluid material. Therefore, a fluid material dispensing apparatus configured to properly dispense the fluid material, in accordance with the type thereof, is required by the users.

Accordingly, the present invention proposes a technique to properly dispense the fluid material, in accordance with the type thereof.

### SUMMARY

In a first aspect, the present invention provides a fluid material dispensing apparatus including a setting section of a cartridge containing a fluid material, a material chamber to which the fluid material is supplied, a valve seat constituting a part of the material chamber and including a dispensing port, a piston configured to move inside the material chamber in a direction toward and away from the dispensing port, and a drive unit for the piston. The cartridge is detachable, and the fluid material dispensing apparatus is configured to accept, as the cartridge, a plurality of cartridges respectively containing different types of fluid material. At least one of the valve seat and the piston is a detachable member that is detachably mounted, and the fluid material dispensing apparatus is configured to accept, as the detachable member, a plurality of detachable members respectively having different structures. The detachable members each include a structure information provider of a corresponding structure. The fluid material dispensing apparatus also includes an information reader that reads information from a material information provider of a corresponding fluid material, provided in each of the cartridges, and information from the structure information provider.

In the fluid material dispensing apparatus configured as above, the detachable member, which is at least one of the valve seat, constituting a part of the material chamber and including the dispensing port, and the piston, is detachably mounted, and the information reader can read the information of the fluid material and the information of the detachable member. Accordingly, the driving condition of the piston can be properly determined, and the appropriate one of the valve seat and the piston can be notified to the user (e.g., whether the valve seat and the piston currently mounted are appropriate), based on the information read by the information reader. Therefore, the fluid material can be properly dispensed in accordance with the type thereof.

In a second aspect, the present invention provides the fluid material dispensing apparatus according to the first aspect, in which both of the valve seat and the piston are a detachable member that can be detachably mounted.

In this case, since both of the valve seat and the piston are the detachable member that can be detachably mounted, the valve seat and the piston can both be replaced with an appropriate one, independently. Therefore, the fluid material can be properly dispensed in accordance with the type thereof, with increased appropriateness.

In a third aspect, the present invention provides the fluid material dispensing apparatus according to the first or second aspect, further including a control unit that controls an operation of the drive unit, based on a reading result of the information reader.

In this case, since the fluid material dispensing apparatus includes the control unit that controls the operation of the drive unit, based on the reading result of the information reader, the driving condition of the piston can be automatically and easily determined.

Here, the expression “control the operation of the drive unit based on the reading result of the information reader” refers to notifying, for example when the control unit decides that the valve seat and the piston currently mounted are not appropriate, such a decision result to the user, and stopping the operation of the piston.

In a fourth aspect, the present invention provides the fluid material dispensing apparatus according to any one of the first to third aspects, further including a notification unit that outputs a detail of control performed by the control unit.

The mentioned configuration enables the control detail of the control unit to be notified to the user, through the notification unit.

Here, the term “control detail” refers to, for example, the driving condition of the piston, information about the type of the fluid material (e.g., properties and type of particles contained), information about the structure of the piston and the valve seat (e.g., piston diameter, size, shape, and material), and the decision result made by the control unit, for example to the effect that the valve seat and the piston currently mounted are not appropriate.

In a fifth aspect, the present invention provides the fluid material dispensing apparatus according to the third or fourth aspect, in which the drive unit is configured to dispense the fluid material through the dispensing port, by bringing the piston into contact with the valve seat, from a position spaced from the valve seat, and further moving the piston in the direction toward the dispensing port, thereby causing the piston to slide along the valve seat, and the control unit may be configured to, in a case where the fluid material contains particles, start to drive the piston when respective sliding surfaces of the piston and the valve seat in contact with each other are higher in Vickers hardness than the particles, but stop driving the piston when the sliding surfaces are lower in Vickers hardness than the particles.

Causing thus the piston to slide along the valve seat, instead of simply driving the piston inside the material chamber (moving the piston in the direction toward the dispensing port), allows the driving force of the piston to be effectively transmitted to the fluid material in the material chamber, thereby stabilizing the dispensing operation. In this case, the sliding surface may wear owing to the particles contained in the fluid material. However, in the case where the fluid material contains particles, the piston starts to be driven when the respective sliding surfaces of the piston and the valve seat in contact with each other are higher in Vickers hardness than the particles, but is not driven when the sliding surfaces are lower in Vickers hardness than the particles. Therefore, the sliding surface can be prevented from wearing, and consequently the dispensing operation can be stably performed over an extended period of time.

### BRIEF DESCRIPTION OF DRAWINGS

FIG. 1 is a schematic drawing showing a configuration of a fluid material dispensing apparatus according to an embodiment 1 of the present invention.

FIG. 2 is a block diagram of the fluid material dispensing apparatus according to the embodiment 1 of the present invention.

FIG. 3 is a schematic drawing showing an essential part of the fluid material dispensing apparatus according to the embodiment 1 of the present invention.

FIG. 4 is another schematic drawing showing the essential part of the fluid material dispensing apparatus according to the embodiment 1 of the present invention.

FIG. 5 is another schematic drawing showing the essential part of the fluid material dispensing apparatus according to the embodiment 1 of the present invention.

FIG. 6 is a schematic drawing showing a configuration of a fluid material dispensing apparatus according to an embodiment 2 of the present invention.

### DETAILED DESCRIPTION OF EMBODIMENTS

Hereafter, the present invention will be described in detail, with reference to the drawings.

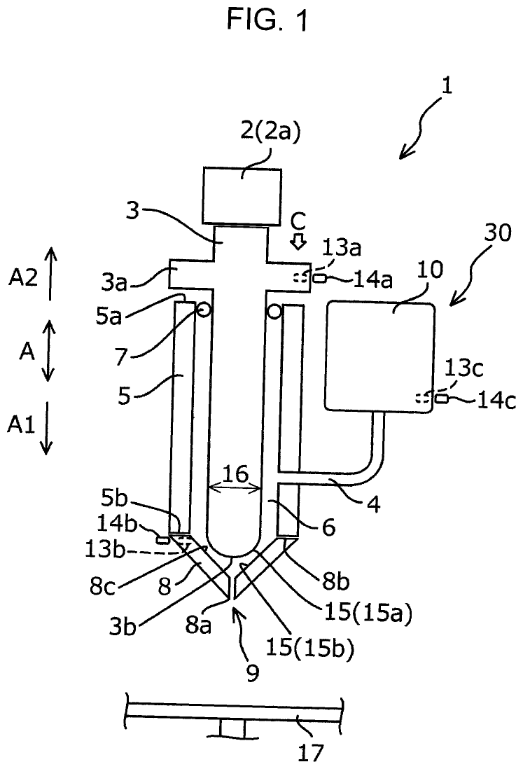

### Embodiment 1 (FIG. 1 to FIG. 5)

First, the outline of a fluid material dispensing apparatus (manufacturing apparatus of 3D objects) according to an embodiment 1 of the present invention will be described.

FIG. 1 is a schematic drawing showing a configuration of the fluid material dispensing apparatus 1 according to this embodiment.

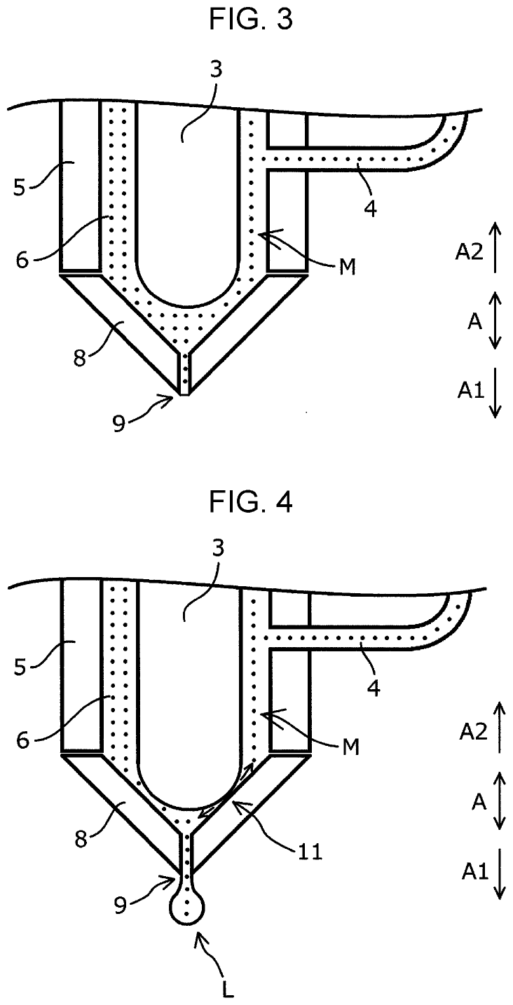

Although the fluid material dispensing apparatus 1 is exemplified by a manufacturing apparatus of 3D objects in this embodiment, the fluid material dispensing apparatus 1 is not limited thereto, provided that the apparatus is configured to dispense a fluid material M (see FIG. 3 to FIG. 5). For example, the fluid material dispensing apparatus 1 may be an ink jet recording apparatus that records an image on a sheet-type recording medium.

The fluid material dispensing apparatus 1 according to this embodiment includes a cartridge 10 containing the fluid material M for forming a 3D object, a cylindrical base portion 5 connected to the cartridge 10 via a tube 4, a piston 3 inserted into the base portion 5 through an end portion 5a, and a valve seat 8 connected to the other end portion 5b of the base portion 5.

The valve seat 8 has a circular conical shape including an inner space of a circular conical shape, and includes a dispensing port 9 formed at a tip portion 8a so as to communicate with the inner space. The valve seat 8 is connected to the end portion 5b of the base portion 5, via a bottom-side end portion 8b. The inner space is formed as result of forming a sloped surface 8c on the inner side of the valve seat 8.

The fluid material dispensing apparatus 1 according to this embodiment also includes a piezoelectric element 2a, serving as a drive unit 2 for the piston 3, configured to move the piston 3 inside the base portion 5 along a direction A, corresponding to the extending direction of the base portion 5.

The piston 3 includes a protruding portion 3a, and is set such that a portion of the piston 3 extending longer from the protruding portion 3a (on the side of a tip portion 3b) is inserted into the base portion 5, and a portion extending shorter from the protruding portion 3a (opposite to the tip portion 3b) is connected to the piezoelectric element 2a.

The piston 3 thus set in position is pressed in a direction C (direction A1 toward the dispensing port 9, out of the direction A), when the piezoelectric element 2a is subjected to a voltage thus to be deformed, and returns to the original position shown in FIG. 1, by moving in a direction A2 opposite to the direction A1, out of the direction A, when the piezoelectric element 2a is released from the voltage and recovers the original shape.

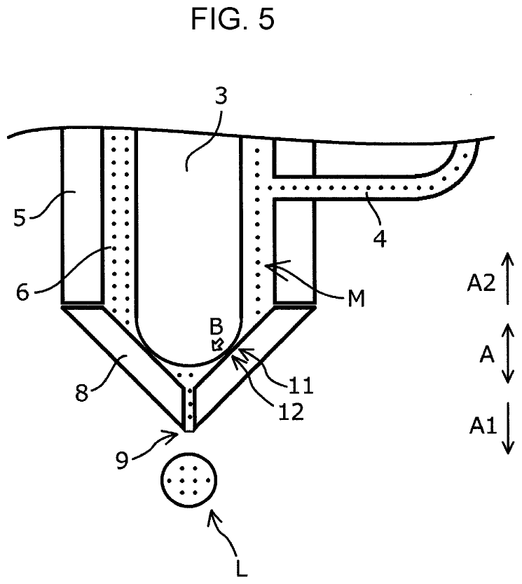

Between the base portion 5 and the piston 3, an O-ring 7 is provided as a seal material. Accordingly, the space defined by the inner surface of the base portion 5 and the valve seat 8, and the piston 3, serves as a material chamber 6 in which the fluid material M supplied from the cartridge 10 is stored. As will be subsequently described in further detail, the fluid material dispensing apparatus 1 according to this embodiment is configured to drive the piston 3 with the fluid material M stored in the material chamber 6 (cause the piston 3 to reciprocate in the direction A1 and the direction A2), to thereby dispense a liquid droplet L (see FIG. 4 and FIG. 5) through the dispensing port 9. In addition, to dispense the liquid droplet L of the fluid material M through the dispensing port 9, the piston 3 is not simply moved toward the dispensing port 9, but made to slide along the valve seat 8 via a sliding surface 15, in other words a sliding surface 15a of the piston 3 and a sliding surface 15b valve seat 8 are made to slide relative to each other.

The fluid material dispensing apparatus 1 according to this embodiment further includes a stage 17 for receiving the liquid droplet L of the fluid material M dispensed through the dispensing port 9, the stage 17 being located so as to oppose the dispensing port 9. The stage 17 is movable in a direction intersecting (orthogonal to) the direction A, as well as in the direction A. Therefore, a desired 3D object can be formed on the stage 17, by moving the stage 17 while dispensing the liquid droplet L of the fluid material M through the dispensing port 9.

Further, in the fluid material dispensing apparatus 1 according to this embodiment, the cartridge 10, the piston 3, and the valve seat 8 are detachable, and therefore a plurality of cartridges 10 for storing different fluid materials M, and a plurality of pistons 3 and valve seats 8 of different structures, can be employed. The cartridge 10 includes a chip 13c serving as a material information provider of the corresponding fluid material M, and the piston 3 and the valve seat 8 respectively includes a chip 13a and a chip 13b, each serving as a structure information provider of the corresponding structure.

Hereunder, an electrical configuration of the fluid material dispensing apparatus 1 according to this embodiment will be described.

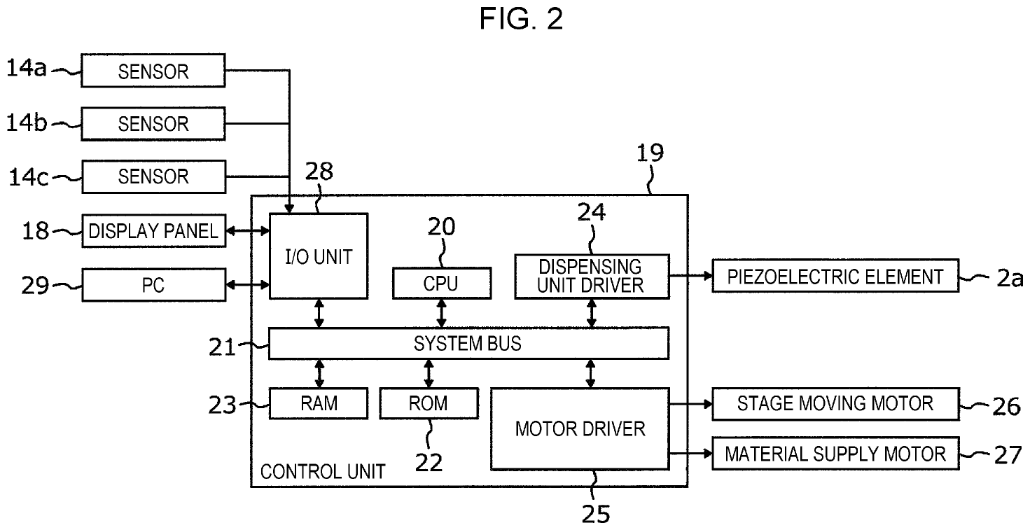

FIG. 2 is a block diagram of the fluid material dispensing apparatus 1 according to this embodiment.

A control unit 19 includes a CPU 20 that serves to control the overall operation of the fluid material dispensing apparatus 1. The CPU 20 is connected, via a system bus 21, to a ROM 22 containing various control programs to be executed by the CPU 20, and a RAM 23 for temporarily storing data.

The CPU 20 is connected to a dispensing driver 24 that drives the piezoelectric element 2a, via the system bus 21.

The CPU 20 is also connected to a motor driver 25, via the system bus 21. The motor driver 25 is connected to a stage moving motor 26 for moving the stage 17, and a material supply motor 27 for supplying the fluid material M from the cartridge 10 to the material chamber 6.

Further, the CPU 20 is connected to an input/output (I/O) unit 28, via the system bus 21. The I/O unit 28 is connected to sensors 14a, 14b, and 14c serving as information readers that respectively read information from the chips 13a, 13b, and 13c, a display panel 18 configured to notify (display) the information read by the sensors 14a, 14b, and 14c to the user, and a PC 29 including a non-illustrated monitor, and configured to transmit and receive data and signals.

With the mentioned configuration, the control unit 19 controls the overall operation of the fluid material dispensing apparatus 1.

As described above, the fluid material dispensing apparatus 1 according to this embodiment includes a setting section 30 of the cartridge 10 containing the fluid material M, the material chamber 6 to which the fluid material M is supplied, the valve seat 8 constituting a part of the material chamber 6 and including the dispensing port, the piston 3 configured to move inside the material chamber 6 in the directions A1 and A2 toward and away from the dispensing port 9, and the drive unit 2 for the piston 3. The cartridge 10 is detachable, and a plurality of cartridges 10 respectively containing different fluid materials M can be employed. At least one of the valve seat 8 and the piston 3 (in this embodiment, both of the valve seat 8 and the piston 3) is a detachable member that can be detachably mounted, and a plurality of detachable members respectively having different structures can be employed. The cartridges 10 each include the chip 13c representing the corresponding fluid material M, and the detachable members (valve seat 8 and piston 3) each include the chip 13a and the chip 13b representing the corresponding structure. Further, the sensors 14a, 14b, and 14c that respectively read the information of the chip 13c, and the chips 13a and 13b.

Thus, in the fluid material dispensing apparatus 1 according to this embodiment, at least one of the valve seat 8, constituting a part of the material chamber 6 and including the dispensing port 9, and the piston 3 is detachable, in other words a detachable member. In addition, the sensors 14a, 14b, and 14c can read the information of the fluid material M and the detachable members. Accordingly, the driving condition of the piston 3 can be properly determined, and the appropriate one of the valve seat 8 and the piston 3 can be notified to the user (e.g., notify whether the valve seat 8 and the piston 3 currently mounted are appropriate, through the display panel 18 or the monitor of the PC 29), based on the information read by the sensors 14a, 14b, and 14c. Therefore, the fluid material dispensing apparatus 1 according to this embodiment enables the fluid material M to be properly dispensed, in accordance with the type thereof.

Here, although in this embodiment the structure information provider is exemplified by the chips 13a and 13b, the material information provider is exemplified by the chip 13c, and the information reader is exemplified by the sensors 14a, 14b, and 14c, different configuration may be adopted. For example, the information may be expressed in a character or a code as the structure information provider and the material information provider, and a reading mechanism of the character or code may be provided, as the information reader.

In particular, since both of the valve seat 8 and the piston 3 are detachable members that can be detachably mounted, in the fluid material dispensing apparatus 1 according to this embodiment, the valve seat 8 and the piston 3 can both be replaced with an appropriate one, independently. Therefore, the fluid material M can be properly dispensed in accordance with the type thereof, with increased appropriateness.

Further, the fluid material dispensing apparatus 1 according to this embodiment includes the control unit 19, configured to control the operation of the drive unit 2 based on the reading result of the sensors 14a, 14b, and 14c. Accordingly, the fluid material dispensing apparatus 1 according to this embodiment enables the driving condition of the piston 3 to be automatically and easily determined.

Here, the expression “control the operation of the drive unit 2 based on the reading result of the sensors 14a, 14b, and 14c” refers to notifying, for example when the control unit 19 decides that the valve seat 8 and the piston 3 currently mounted are not appropriate, such a decision result to the user, and stopping the operation of the piston 3.

Table 1 given hereunder indicates judgment examples, about whether the valve seat 8 and piston 3 currently mounted are appropriate. The fluid material dispensing apparatus 1 according to this embodiment is designed to employ tungsten carbide (WC; Vickers hardness approximately 1700 to 2050) and diamond-like carbon (DLC; Vickers hardness approximately 7000 to 15300), to form the sliding surface 15 of the valve seat 8 and the piston 3 (sliding surface 15a of the piston 3 and sliding surface 15b of the valve seat 8). On the part of the fluid material M, materials containing copper particles (Cu; Vickers hardness approximately 400 or lower), stainless steel particles (SUS; Vickers hardness approximately 200 to 400), silicon dioxide particles (SiO₂; Vickers hardness approximately 1100), or alumina particles (Al₂O₃; Vickers hardness approximately 2300) may be employed. With respect to the materials cited above, the control unit 19 is configured to display “OK” when the valve seat 8 and piston 3 currently mounted are appropriate, and “NG” in the contrary case, according to Table 1, on the display panel 18 and the monitor of the PC 29.

TABLE 1

Fluid Material

| Valve Seat | Piston | Cu | SUS | SiO₂ | Al₂O₃ |
|---|---|---|---|---|---|
| WC | WC | OK | OK | NG | NG |
| WC | DLC | NG | NG | NG | NG |
| DLC | WC | NG | NG | NG | NG |
| DLC | DLC | OK | OK | OK | OK |

The fluid material dispensing apparatus 1 according to this embodiment includes the display panel 18, serving as a notification unit that notifies the control detail of the control unit 19. Accordingly, the fluid material dispensing apparatus 1 according to this embodiment is configured to notify the user about the control detail of the control unit 19, such as a decision according to the example shown in Table 1, and the driving condition of the piston 3 to be adopted when the valve seat 8 and the piston 3 currently mounted are appropriate.

Here, the term “control detail” refers to, for example, the driving condition of the piston, the information about the type of the fluid material M (e.g., properties and type of particles contained), the information about the structure of the piston 3 and the valve seat 8 (e.g., piston diameter 16, size, shape such as the angle of the sloped surface 8c, and material), and the decision result made by the control unit 19, for example to the effect that the valve seat 8 and the piston 3 currently mounted are not appropriate.

Further, in the fluid material dispensing apparatus 1 according to this embodiment, the drive unit 2 is configured to dispense the fluid material M through the dispensing port 9, by bringing the piston 3 into contact with the valve seat 8, from a position spaced therefrom, and further moving the piston 3 in the direction A1 toward the dispensing port 9, thereby causing the piston 3 to slide along the valve seat 8. The control unit 19 is configured to, in the case where the fluid material M contains particles, start to drive the piston 3 when the respective sliding surfaces 15 of the piston 3 and the valve seat 8 in contact with each other are higher in Vickers hardness than the particles (corresponding to OK in Table 1), but stop driving the piston 3 when the sliding surfaces are lower in Vickers hardness than the particles (corresponding to NG in Table 1).

Causing thus the piston 3 to slide along the valve seat 8, instead of simply driving the piston 3 inside the material chamber 6 (moving the piston 3 in the direction A1 toward the dispensing port 9), allows the driving force of the piston 3 to be effectively transmitted to the fluid material M in the material chamber 6, thereby stabilizing the dispensing operation. In this case, the sliding surface 15 may wear owing to the particles contained in the fluid material M. However, in the fluid material dispensing apparatus 1 according to this embodiment, when the fluid material M contains particles, the piston 3 starts to be driven when the respective sliding surfaces 15 of the piston 3 and the valve seat 8 in contact with each other are higher in Vickers hardness than the particles, but is not driven when the sliding surfaces 15 are lower in Vickers hardness than the particles. Therefore, the sliding surface 15 can be prevented from wearing, and consequently the dispensing operation can be stably performed over an extended period of time.

The operation of the piston 3, performed inside the material chamber 6 to dispense the fluid material M, will now be described in detail hereunder.

FIG. 3 to FIG. 5 are schematic drawings each showing an essential part of the fluid material dispensing apparatus 1, in which the fluid material M is supplied to (loaded in) the material chamber 6. FIG. 3 illustrates a state where the piston 3 is spaced from the valve seat 8 (same position as in FIG. 1). FIG. 4 illustrates a state where the piston 3 has been moved in the direction A1 toward the dispensing port 9 from the position shown in FIG. 3, so as to contact a slide start position 11 on the valve seat 8. FIG. 5 illustrates a state where the piston 3 has been further moved in the direction A1 toward the dispensing port 9 from the position shown in FIG. 4, so as to slide along the valve seat 8 until reaching a slide end position 12. Here, the term “contact” includes a state where the piston 3 is spaced from the valve seat 8 by an extremely minute distance, for example in contact via the particles contained in the fluid material M.

In the fluid material dispensing apparatus 1 according to this embodiment, the drive unit 2 is configured to dispense the liquid droplet L of the fluid material M, by bringing the piston 3 into contact with the slide start position 11 on the valve seat 8 (FIG. 4), from the position spaced therefrom (FIG. 3), and then moving the piston 3 so as to slide along the valve seat 8 as far as the slide end position 12 (FIG. 5). Then the piston 3 is returned to the position spaced from the valve seat 8 (FIG. 3), and the transition of the position from the state shown in FIG. 3 to the state shown in FIG. 5 (movement of the piston 3) is repeated, to successively dispense the liquid droplet L of the fluid material M.

To be more detailed, in the state of FIG. 4 reached after the state of FIG. 3, the slide start position 11 constitutes a watershed upon being contacted by the piston 3, and the fluid material M is squeezed to both sides of the slide start position 11. Then the squeezing force exerted on the fluid material M forms the liquid droplet L at the dispensing port 9. Here, the term “slide” includes a state where the piston 3 moves with an extremely minute gap, for example moving in a slide direction B with the particles contained in the fluid material M interposed.

When the state of FIG. 5 is reached after the state of FIG. 4, the fluid material M is further squeezed owing to the movement of the piston 3 from the slide start position 11 to the slide end position 12 along the slide direction B, so that the liquid droplet L formed at the dispensing port 9 is separated from the dispensing port 9, and dispensed in the direction A1.

The fluid material dispensing apparatus 1 according to this embodiment is configured to successively dispense the liquid droplets L from the dispensing port 9 as above, and move the stage 17 in the direction intersecting the direction A, to thereby form a first layer of the 3D object, on the stage 17. When the first layer of the 3D object has been formed, the stage 17 is moved in the direction A1 by a distance corresponding to a thickness of one layer, and the second layer of the 3D object is formed on the first layer of the 3D object. Thereafter, the same operation is repeated until the desired 3D object is obtained, by forming the third layer, the fourth layer, and so forth, so as to form the layered body of the desired 3D object.

As described above, the fluid material dispensing apparatus 1 according to this embodiment includes the material chamber 6 to which the fluid material M, containing at least one of metal particles and ceramic particles, is supplied, the valve seat 8 constituting a part of the material chamber 6 and including the dispensing port 9, the piston 3 configured to move inside the material chamber 6 in the directions A1 and A2 toward and away from the dispensing port 9, and the drive unit 2 for the piston 3.

As shown in FIG. 3 to FIG. 5, the drive unit 2 is configured to bring the piston 3 into contact with the valve seat 8 (FIG. 4), from the position spaced therefrom (FIG. 3), and further move the piston 3 in the direction A1 toward the dispensing port 9 so as to slide along the valve seat 8 (FIG. 5), to thereby dispense the fluid material M through the dispensing port 9.

Further, employing the cartridge 10, the piston 3, and the valve seat 8 in one of the combinations indicated as OK in Table 1 allows the respective sliding surfaces 15 of the piston 3 and the valve seat 8 in contact with each other to attain a higher Vickers hardness than that of the particles contained in the fluid material M.

The fluid material dispensing apparatus 1 according to this embodiment is configured to cause the piston 3 to slide along the valve seat 8, instead of simply driving the piston 3 inside the material chamber 6 (moving the piston 3 in the direction A1 toward the dispensing port 9), and therefore the driving force of the piston 3 can be effectively transmitted to the fluid material M in the material chamber 6, thereby stabilizing the dispensing operation. In this case, the sliding surface 15 may wear owing to the particles contained in the fluid material M. However, the sliding surfaces 15 are given a higher Vickers hardness than that of the particles contained in the fluid material M, and therefore the wear is prevented, and the dispensing operation can be stably performed over an extended period of time. More specifically, the fluid material M containing particles having a high Vickers hardness, such as metal particles and ceramic particles, can be stably dispensed for a long period of time. Further, preventing the sliding surface 15 from wearing also contributes to preventing the constituent material of the sliding surface 15 from being mixed in the fluid material M (preventing the fluid material M from being contaminated by impurities).

The sliding surfaces 15 according to this embodiment, namely the sliding surfaces 15a and 15b, are both formed of diamond-like carbon. Since the sliding surface 15 is thus formed of diamond-like carbon, which is particularly high in Vickers hardness, the long-term stabilized dispensation of the fluid material M containing particles having a high Vickers hardness, such as metal particles and ceramic particles, can be further assured.

In addition, since the diamond-like carbon is particularly high in Vickers hardness, in most cases the Vickers hardness of the sliding surface 15 is higher than that of the particles contained in the fluid material M, even though the material of the particles is unknown. Therefore, the fluid material M can be stably dispensed for a long time, even though the user is unaware of the type of the particles contained in the fluid material M.

More specifically, the sliding surfaces 15 according to this embodiment, namely the sliding surfaces 15a and 15b, are both formed of a diamond-like carbon film having a thickness equal to or thicker than 200 nm.

With a thickness of 200 nm or more, the diamond-like carbon film can be exempted from incurring a pinhole. In other words, in the fluid material dispensing apparatus 1 according to this embodiment, the sliding surface 15 is formed of the diamond-like carbon film having a thickness of 200 nm or more, and therefore the diamond-like carbon film can be prevented from being peeled off, from the position where the pinhole is formed. Accordingly, the fluid material dispensing apparatus 1 according to this embodiment is configured to stably dispense, with further increased security, the fluid material M containing particles having a high Vickers hardness, such as metal particles and ceramic particles, for a long period of time.

The composition of the diamond-like carbon is not specifically limited, and may either be free from hydrogen, or contain hydrogen in a certain ratio. However, it is preferable that the hydrogen content is low. Whereas the diamond-like carbon has an amorphous structure of a hybrid orbital of sp²-orbital and spa-orbital, it is preferable that the content of the spa-orbital is higher, from the viewpoint of attaining a higher Vickers hardness.

Further, whereas the diamond-like carbon film constituting the sliding surface 15 according to this embodiment has a layered structure, forming the layers such that an inner layer has a higher Vickers hardness than that of an outer layer effectively prevents the diamond-like carbon film from being damaged or peeled off.

Forming the constituent parts of the flow path for the fluid material M, which is in contact therewith, from a material having a higher Vickers hardness than that of the particles contained in the fluid material M, not only the sliding surface 15, prevents such parts from wearing, like the case of the sliding surface 15.

Here, the term “constituent parts of the flow path for the fluid material M” refers to all the parts that have a chance to contact the fluid material M, the examples of which include the inner surface of the cartridge 10, the inner wall of the tube 4 and the base portion 5, the entirety of the sloped surface 8c of the valve seat 8, and the dispensing port 9 (the entirety of the nozzle including the region from the sloped surface 8c to the dispensing port 9).

It is preferable that the sliding surface 15 has a Vickers hardness higher by 500 or more, than that of the hardest particles among the particles contained in the fluid material M, because in this case the long-term stabilized dispensation of the fluid material M containing particles having a high Vickers hardness, such as metal particles and ceramic particles, can be further assured.

Accordingly, as shown in Table 1, the control unit 19 of the fluid material dispensing apparatus 1 according to this embodiment is configured to display OK on the display panel 18, when the combination of the cartridge 10, the piston 3, and the valve seat 8 attains a Vickers hardness higher by 500 or more, than that of the hardest particles among the particles contained in the fluid material M.

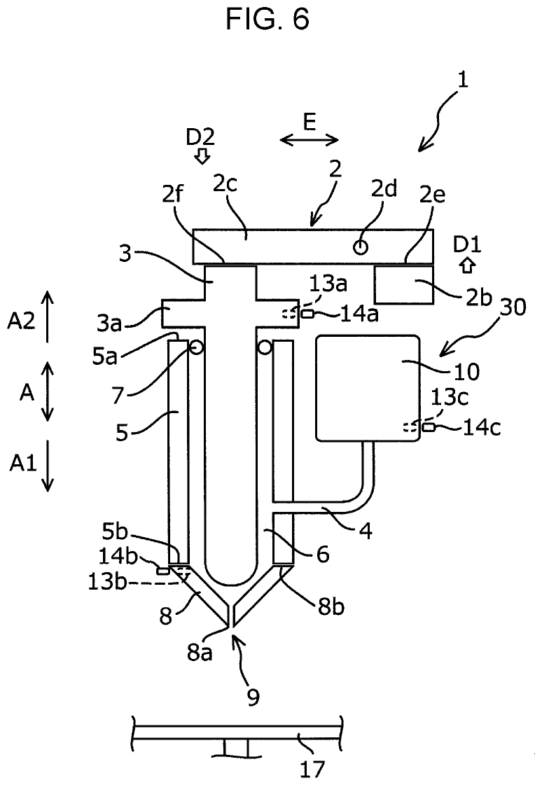

### Embodiment 2 (FIG. 6)

Hereunder, the fluid material dispensing apparatus 1 according to an embodiment 2 will be described in detail, with reference to the drawing.

FIG. 6 is a schematic drawing showing a configuration of the fluid material dispensing apparatus 1 according to the embodiment 2, viewed in the same direction as FIG. 1 showing the fluid material dispensing apparatus 1 according to the embodiment 1.

The fluid material dispensing apparatus 1 according to this embodiment is configured similarly to the fluid material dispensing apparatus 1 of the embodiment 1, except for the configuration of the drive unit 2, and the same elements as those of the fluid material dispensing apparatus 1 of the embodiment 1 are given the same numeral.

The drive unit 2 according to the embodiment 1 includes the piezoelectric element 2a, to deform the piezoelectric element 2a in the direction A1 by applying a voltage thereto, thus to press the piston 3 in the direction A1.

In contrast, the drive unit 2 according to this embodiment includes a piezoelectric element 2b and a bar-shaped portion 2c. The bar-shaped portion 2c includes a rotation shaft 2d, such that the lower face of the bar-shaped portion 2c, on one side 2e of the rotation shaft 2d, is in contact with the piezoelectric element 2b, and the lower face of the bar-shaped portion 2c on the other side 2f is in contact with the piston 3. When a voltage is applied to the piezoelectric element 2b, the piezoelectric element 2b is deformed in a direction D1 (direction A2) so as to press the one side 2e upward. Accordingly, the piston 3 is pressed in a direction D2 (direction A1), based on the principle of leverage (contact point of the one side 2e and the piezoelectric element 2b corresponds to the point of effort, the rotation shaft 2d corresponds to the fulcrum, and the contact point of the other side 2f and the piston 3 corresponds to the point of action).

The drive unit 2 according to this embodiment (piezoelectric element 2b and the bar-shaped portion 2c) is configured to move in a direction E as a whole, with respect to the piston 3, so as to adjust the pressing force (pressing stroke) exerted on the piston 3 in the direction D2, by changing the contact point (position) between the other side 2f and the piston 3. Therefore, the size of the liquid droplet L dispensed from the dispensing port 9 (dispensation amount of the fluid material M) can be effectively adjusted.

However, the configuration of the drive unit 2 is not limited to the examples of the embodiments 1 and 2. For example, a spring and a compression mechanism therefor, or a pneumatic pressure control mechanism may be employed, in place of the piezoelectric element 2a or 2b.

The present invention is not limited to the foregoing embodiments, but may be realized in various different manners within the scope of the invention. For example, although the piston 3 is set to be pressed in the direction A1, the piston 3 may be pressed in a direction intersecting the direction A1, depending on the eccentricity or processing accuracy of the piston 3. In such a case also, the wear originating from the contact and sliding can be suppressed. The technical features described in the embodiments may be substituted or combined as desired, to eliminate all or a part of the conventional drawbacks, or attain a part or the whole of the foregoing advantageous effects. Further, any of the technical features may be excluded, unless such features are herein described as mandatory.

The entire disclosure of Japanese Patent Application No.: 2016-187175, filed Sep. 26, 2016 is expressly incorporated by reference herein.

1. A fluid material dispensing apparatus comprising;
a setting section of a cartridge containing a fluid material;
a material chamber to which the fluid material is supplied;
a valve seat constituting a part of the material chamber and including a dispensing port;
a piston configured to move inside the material chamber in a direction toward and away from the dispensing port; and
a drive unit for the piston, wherein
the cartridge is detachable, the fluid material dispensing apparatus being configured to accept, as the cartridge, a plurality of cartridges respectively containing different types of the fluid material,
at least one of the valve seat and the piston is a detachable member that is detachably mounted, the fluid material dispensing apparatus being configured to accept, as the detachable member, a plurality of detachable members respectively having different structures, and
the detachable members each include a structure information provider of a corresponding structure,
the fluid material dispensing apparatus further comprising an information reader that reads information from a material information provider of a corresponding fluid material, provided in each of the cartridges, and information from the structure information provider.

2. The fluid material dispensing apparatus according to claim 1, wherein
both of the valve seat and the piston are a detachable member that can be detachably mounted.

3. The fluid material dispensing apparatus according to claim 1, further comprising a control unit that controls an operation of the drive unit, based on a reading result of the information reader.

4. The fluid material dispensing apparatus according to claim 3, further comprising a notification unit that outputs a detail of control performed by the control unit.

5. The fluid material dispensing apparatus according to claim 3, wherein
the drive unit is configured to dispense the fluid material through the dispensing port, by bringing the piston into contact with the valve seat, from a position spaced from the valve seat, and further moving the piston in the direction toward the dispensing port, thereby causing the piston to slide along the valve seat, and
the control unit is configured to, in a case where the fluid material contains particles, start to drive the piston when respective sliding surfaces of the piston and the valve seat in contact with each other are higher in Vickers hardness than the particles, but stop driving the piston when the sliding surfaces are lower in Vickers hardness than the particles.

6. The fluid material dispensing apparatus according to claim 2, further comprising a control unit that controls an operation of the drive unit, based on a reading result of the information reader.

7. The fluid material dispensing apparatus according to claim 6, further comprising a notification unit that outputs a detail of control performed by the control unit.

8. The fluid material dispensing apparatus according to claim 4, wherein
the drive unit is configured to dispense the fluid material through the dispensing port, by bringing the piston into contact with the valve seat, from a position spaced from the valve seat, and further moving the piston in the direction toward the dispensing port, thereby causing the piston to slide along the valve seat, and
the control unit is configured to, in a case where the fluid material contains particles, start to drive the piston when respective sliding surfaces of the piston and the valve seat in contact with each other are higher in Vickers hardness than the particles, but stop driving the piston when the sliding surfaces are lower in Vickers hardness than the particles.

9. The fluid material dispensing apparatus according to claim 6, wherein
the drive unit is configured to dispense the fluid material through the dispensing port, by bringing the piston into contact with the valve seat, from a position spaced from the valve seat, and further moving the piston in the direction toward the dispensing port, thereby causing the piston to slide along the valve seat, and
the control unit is configured to, in a case where the fluid material contains particles, start to drive the piston when respective sliding surfaces of the piston and the valve seat in contact with each other are higher in Vickers hardness than the particles, but stop driving the piston when the sliding surfaces are lower in Vickers hardness than the particles.

10. The fluid material dispensing apparatus according to claim 7, wherein
the drive unit is configured to dispense the fluid material through the dispensing port, by bringing the piston into contact with the valve seat, from a position spaced from the valve seat, and further moving the piston in the direction toward the dispensing port, thereby causing the piston to slide along the valve seat, and
the control unit is configured to, in a case where the fluid material contains particles, start to drive the piston when respective sliding surfaces of the piston and the valve seat in contact with each other are higher in Vickers hardness than the particles, but stop driving the piston when the sliding surfaces are lower in Vickers hardness than the particles.
